(19) United States
(12) Patent Application Publication
(10) Pub. No.: US 2024/0189901 A1
(43) Pub. Date: Jun. 13, 2024

(54) METHOD FOR MANUFACTURING A COMPONENT WITH SOFT MAGNETIC PROPERTIES

(71) Applicant: Miba Sinter Austria GmbH, Laakirchen (AT)

(72) Inventors: Anna FRUEHWIRTH, Roitham (AT); Laura GALVAO BARBOSA DE OLIVEIRA, Indaiatuba (BR); Robert HELLEIN, Ungenach (AT); Markus SCHAUER, Gunskirchen (AT)

(73) Assignee: Miba Sinter Austria GmbH, Laakirchen (AT)

(21) Appl. No.: 18/527,651

(22) Filed: Dec. 4, 2023

(30) Foreign Application Priority Data
Dec. 12, 2022 (AT) A 50944/2022

(51) Int. Cl. B22F 3/02; B22F 1/05; B22F 1/16; B22F 3/24; H01F 1/20

(52) U.S. Cl. CPC B22F 3/02; B22F 1/05; B22F 1/16; B22F 3/24; H01F 1/20; B22F 2003/247; B22F 2003/248; B22F 2304/10; B22F 2998/10; B22F 2999/00

(57) ABSTRACT

A method for producing a component with soft magnetic properties from particles of a SMC powder includes the steps of: pressing a SMC powder into a green compact, heat treatment of the green compact; wherein machining is performed after powder pressing and before heat treatment of the green compact in the green state.

### CROSS REFERENCE TO RELATED APPLICATIONS

Applicant claims priority under 35 U.S.C. § 119 of Austrian Application No. A 50944/2022 filed Dec. 12, 2022, the disclosure of which is incorporated by reference.

### BACKGROUND OF THE INVENTION

### 1. Field of the Invention

The invention relates to a method of manufacturing a component with soft magnetic properties from particles of a SMC powder comprising the steps of: pressing a SMC powder into a green compact, heat treatment of the green compact and, if necessary, reworking of the heat-treated green compact.

The invention also relates to a component with soft magnetic properties comprising a component body at least partially consisting of a pressed and heat-treated SMC powder.

### 2. Description of the Related Art

SMC powders (soft magnetic composites) have been known for a long time. These are powders with particles of soft magnetic material whose surface is coated with an electrically insulating layer. These powders are consolidated into soft magnetic components by pressing. Due to the increasing importance of electromobility, SMC powders are now used in manufacturing electric motor components because, unlike conventional laminated sheets, they enable a three-dimensional alternating magnetic flux with low losses. This makes it possible to build vehicles that are lighter with the same performance or that provide a higher performance with the same weight of the drive as before. In addition to electromobility, there are also other electromagnetic applications for these powders.

SMC powders have also found their way into the patent literature. For example, AT 511 919 A1 describes a sintered component with soft magnetic properties comprising metallic particles and at least one metal oxide, wherein the metal oxide is formed from at least a portion of the metallic particles and forms an oxide layer on at least a portion of the surface of these particles.

A method of manufacturing a sintered component with soft magnetic properties is known from AT 521 006 A1, comprising the steps of: filling the SMC powder into a powder press, pressing the SMC powder into the component, removing the component from the powder press, if necessary, reworking the component, wherein the pressing of the SMC powder into the component is carried out at a temperature between 300° C. and 650° C.

### SUMMARY OF THE INVENTION

The present invention is based on the object of improving the manufacture of a component with soft magnetic properties and providing a corresponding component with soft magnetic properties.

The object of the invention is solved in the above-mentioned method in that a machining to be carried out in the course of manufacturing the component is performed after powder pressing and before heat treatment of the green compact in the green state.

Furthermore, the object of the invention is solved for the component mentioned at the beginning by the component body having a machined surface which has a surface roughness with an arithmetic mean roughness value Ra according to DIN EN ISO 4287:2010 of between 0.1 μm and 10 μm.

The advantage here is that, due to the lower cohesion of the particles in the green compact, the particles break out completely during machining. Although breaking out whole particles results in a correspondingly rough surface, this has the advantage over machining the heat-treated component that the electrical insulation layer of the particles does not break open and therefore the iron is not smeared on the surface during machining. As a result, eddy current losses due to smeared iron are avoided or at least significantly reduced. As a side effect, machining in the green state may also make it easier to produce component geometries that cannot be produced using press technology.

To simplify the removal of whole particles from the surface of the green compact, according to an embodiment variant of the invention it may be provided that the particles of the SMC powder with an average particle size according to ISO 4497:2020 of between 60 μm and 500 μm are used.

Also to simplify the removal of whole particles, according to another embodiment variant of the invention it may be provided that particles of the SMC powder are used which at least partially have an insulation layer with a layer thickness of at least 2 nm and at most 20 μm. An appropriately thick insulation layer can prevent their destruction during machining.

In order to increase the thickness of the electrical insulation layer and to heal damages from the pressing process, an embodiment variant of the invention may provide for the component made from the SMC powder to be additionally oxidized after pressing.

According to another embodiment variant of the invention, it may be provided that the green compact is heated to a temperature of between 30° C. and 300° C. for machining. This allows lower mechanical stresses to be introduced into the green compact during machining.

According to another embodiment variant of the invention, in order to better prevent the electrical insulation layer of the particles from breaking up during machining, it may be provided that the machining is carried out using a cutting tool with a cutting edge, the cutting edge being guided at an angle of between 75° and 105° to the surface of the green compact to be machined during the machining.

Although the highest possible density is advantageous for the electromagnetic properties of the component, according to a further embodiment variant of the invention it may be provided that the green compact is manufactured with a density of at most 95% of the full density of the material from which the green compact is manufactured. This may simplify the removal of particles from the particle composite of the green compact.

According to an embodiment variant of the invention, it may provided that the machined surface of the component has an average surface roughness Rz according to DIN EN ISO 4287:2010 of between 1 μm and 50 μm in order to even out the machined surface of the component.

A component with improved properties in terms of eddy current losses may be achieved with another embodiment variant of the invention, according to which the SMC powder comprises iron, the proportion of iron measured on the machined surface of the component body of the component being a maximum of 90 m %. The invention can therefore achieve a significantly lower proportion of iron on the surface compared to components machined after heat treatment, which have an iron content on the surface of between 95 m % and 97 m %.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the Drawings,

FIG. 1 shows a cross-section of a component; and

FIG. 2 shows a machining of the component with a cutting tool.

### DETAILED DESCRIPTION OF PREFERRED EMBODIMENTS

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

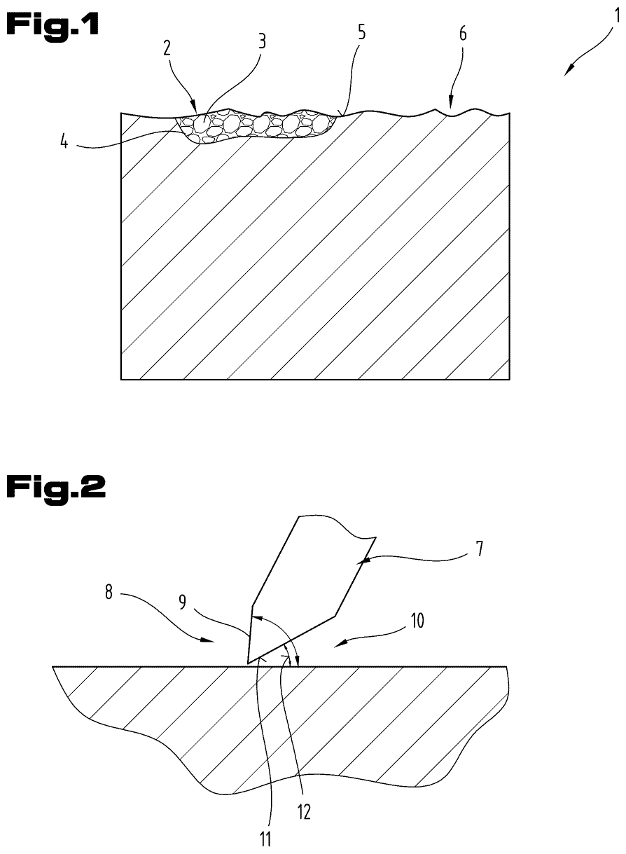

FIG. 1 shows a cross-section of a component 1.

The component 1 according to FIG. 1 serves only to clarify the invention. Its shape therefore has no restrictive character for the invention.

The component 1 comprises or consists of particles 2 made of at least one SMC material (SMC=soft magnetic composite). The particles 2 form a compact body due to deformation during consolidation, which has a corresponding stability. By using an SMC material, i.e. a soft magnetic material, the component 1 has soft magnetic properties.

The term “soft magnetic materials” refers to materials with low remanence, in accordance with technical terminology.

The particles 2 of the SMC powder or SMC material are provided with a core 3 which is surrounded by an electrical insulation layer 4 or several electrical insulation layers 4, or consist of the core 3 and the at least one electrical insulation layer 4, as indicated in FIG. 1 by means of a particle 2. If necessary, a binder layer may also be applied to the outside of the insulation layer, with which the individual particles 2 may be bonded.

The core 3 may have or consist of a pure iron powder. However, other magnetizable materials or alloys may also be used as a core 3, such as iron alloys with Si and/or Ni and/or P.

In particular, this core 2 is completely surrounded by the at least one electrical insulation layer 4. The at least one electrical insulation layer 4 may be organic, e.g. a silicone coating, or metal-organic or inorganic in nature, e.g. an oxide layer, a silicate layer, a phosphate layer, a metal layer. In the case of several electrical insulation layers 4, these may also consist of different materials, for example selected from the materials mentioned.

The binder layer, if present, may be a polymer layer, e.g. PTFE, wax, etc.

In principle, this configuration of SMC powders is known from the prior art, so that further explanations regarding this may be dispensed with.

To manufacture the component 1, the SMC powder, i.e. the particles 2 consisting of the SMC material, is premixed if necessary, if a powder mixture is used. Further manufacturing is carried out by powder metallurgy. For this purpose, the particles 2 consisting of the SMC material are pressed into a green compact. Pressing may take place in a die, for example, or by extrusion or injection molding. The green compacts are heat-treated in one or more stages at a temperature between 450° C. and 650° C. to form the component 1. After heat treatment, the component 1 may be reworked if necessary.

Since manufacturing of such components 1 by powder metallurgy is known per se from the prior art, reference is made to the relevant prior art for details of this method in order to avoid repetition, for example to AT 511 919 A1 mentioned at the beginning.

Preferably, no machining of component 1 is carried out after heat treatment of the green compact. Machining is carried out, preferably exclusively, on the green compact after powder pressing and before heat treatment of the green compact. The machining may consist of: turning, drilling, countersinking, reaming, milling, planing, broaching, filing, rasping, scraping, honing, etc.

When a surface of the green compact is machined, particles 2 are removed from the pressed composite so that recesses 6 are present in a surface 5 of the component 1 in which the removed particles 2 have been disposed. The surface 5 of the component 1 has a surface roughness with an arithmetic mean roughness value Ra according to DIN EN ISO 4287:2010 of between 0.1 μm and 10 μm, in particular between 0.5 μm and 8 μm. According to an embodiment variant, the surface 5 may have an average surface roughness Rz according to DIN EN ISO 4287:2010 of between 1 μm and 50 μm.

The roughness of the surface 5 of the component 1 may be predefined by the particle size or the particle size distribution.

The machining may concern only one surface or several or all surfaces of the green compact, so that only one surface 5 or several or all surfaces 5 of the component 1 is/are formed accordingly.

Furthermore, the machining of the green compact may only serve to reduce the tolerances of the component 1. Alternatively or additionally, it is also possible for the machining process to be a shaping process in itself, in which recesses, undercuts, grooves, etc. are introduced in the green compact. It is therefore also possible to design components 1 that cannot be produced using press technology.

According to another embodiment variant, it may be provided that the SMC powder comprises iron, wherein the proportion of iron measured on the machined surface 5 of the component body of component 1 is at most 90 m % (mass percent), in particular at most 85 m %. The proportion of iron was determined using an EDX (scanning electron microscope). The iron content therefore reflects the proportion of bound iron (i.e. surrounded by an insulation layer 4) and free iron. If the insulation layer 4 also contains iron, e.g. consists of iron phosphate, this proportion is also included in the specified maximum value. The remainder of 100 m % consists of the other components of the component, in particular the components of the insulation layer 4.

In principle, particles 2 of the SMC powder with a particle size of up to 800 μm may be used. Preferably, however, according to an embodiment variant, particles 2 of the SMC powder are used which have an average particle size according to ISO 4497:2020 of 60 μm to 500 μm, in particular between 200 μm and 400 μm. An at least partially agglomerated SMC powder may also be used. The agglomerate size may be between 60 μm and 600 μm.

It is also possible to use a SMC powder consisting of particles 2 with several particle size fractions. For example, a SMC powder may be used that consists of particles 2 of a first particle fraction with particle sizes between 10 μm and 300 μm and particles 2 of a second particle fraction with particle sizes between 200 μm and 450 μm. The proportion of the first fraction in the total SMC powder may be between 40 wt. % and 60 wt. % and the proportion of the second fraction in the total SMC powder may be between 60 wt. % and 40 wt. %. On the one hand, this results in better mold filling. On the other hand, a more even surface 5 can also be achieved in the component. Furthermore, this may also simplify dewaxing.

The electrical insulation layer(s) 4 may have a layer thickness of at least 2 nm and at most 50 nm μm, in particular of at least 2 nm and at most 30 nm. An average layer thickness (arithmetic mean of at least ten individual values) of the electrical insulation layer(s) 4 may be between 2 nm and 20 μm.

If necessary, the component 1 or the particles 2 of the SMC powder may be additionally oxidized after pressing.

For the purposes of the invention, oxidation is understood to mean in particular the formation of an oxide from a metal or semimetal.

The oxidation of the particles 2 may be carried out with air or water vapor at a temperature between 100° C. and 700° C. once or several times.

The pressing of the particles 2 to form the green compact may be carried out using known methods. The green compact may be produced with a density of 94% to 98% of the full density of the material from which the green compact is manufactured. According to an embodiment variant of the method, however, it may be provided that the green compact is only manufactured with a density of at most 95%, in particular at most 93%, of the full density of the material from which the green compact is manufactured.

According to a further embodiment variant of the method, the green compact may be heated to a temperature of between 30° C. and 300° C. for machining. Heating can take place in a (continuous) furnace, for example. It is also possible that the shaping tool is already operated at a higher temperature, for example the die is kept at a higher temperature so that the green compact can already be removed from the shaping tool for machining at the specified temperature.

FIG. 2 shows an embodiment variant of the machining of a surface of the green compact. The machining is carried out using a cutting tool 7 with a cutting edge 8. The cutting edge 8, in particular a rake face 9 of the cutting tool 7, is guided at an angle 10 of between 75° and 105°, in particular between 85° and 95°, to the surface of the green compact to be machined during machining. A flank 11 of the cutting tool 7 may be guided at an angle 12 of between 87° and 93° to the surface of the green compact to be machined. Secondary flanks may be guided at an angle of between 10° and 25° and between 15° and 25° to the surface of the green compact to be machined.

The component 1 may be intended for automotive applications, for example. Other applications may be: parts for active components for axial flow motors, a rotor, a stator, inductive elements, etc.

The exemplary embodiments show or describe possible embodiment variants, wherein combinations of the individual embodiment variants are also possible.

Finally, for the sake of order, it should be noted that for a better understanding of the structure of the component 1 or the cutting tool 7, these are not necessarily shown to scale.

Although only a few embodiments of the present invention have been shown and described, it is to be understood that many changes and modifications may be made thereunto without departing from the spirit and scope of the invention.

### REFERENCE SIGNS LIST

1 component
2 particle
3 core
4 insulation layer
5 surface
6 recess
7 cutting tool
8 cutting edge
9 rake face
10 angle
11 flank
12 angle

What is claimed is:

1. A method of manufacturing a component (1) having soft magnetic properties from particles (2) of a SMC powder comprising the steps of:
pressing a SMC powder into a green compact,
heat treatment of the green compact;
if necessary, reworking the heat-treated green compact,
wherein machining is carried out after powder pressing and before heat treatment of the green compact in the green state.

2. The method according to claim 1, wherein the particles (2) of the SMC powder with an average particle size of between 60 μm and 500 μm are used.

3. The method according to claim 1, wherein particles (2) of the SMC powder are used which at least partially have an insulation layer (4) with a layer thickness of at least 2 nm and at most 20 μm.

4. The method according to claim 3, wherein the component (1) or the particles (2) of the SMC powder are additionally oxidized after pressing.

5. The method according to claim 1, wherein the green compact is heated to a temperature between 30° C. and 300° C. for machining.

6. The method according to claim 1, wherein the machining is carried out using a cutting tool (7) with a cutting edge (8), the cutting edge (8) being guided at an angle of between 75° and 105° to the surface of the green compact to be machined during the machining.

7. The method according to claim 1, wherein the green compact is produced with a density of at most 95% of the full density of the material from which the green compact is manufactured.

8. A component (1) with soft magnetic properties comprising a component body at least partially consisting of a pressed and heat-treated SMC powder, wherein the component body has a machined surface (5) which has a surface roughness with an arithmetic mean roughness value Ra according to DIN EN ISO 4287:2010 of between 0.1 μm and 10 μm.

9. The component (1) according to claim 8, wherein a machined surface (5) has an average surface roughness Rz according to DIN EN ISO 4287:2010 of between 1 μm and 50 μm.

10. The component (1) according to claim 8, wherein the SMC powder comprises iron, the proportion of iron measured on the machined surface (5) of the component body being at most 90 m %.
